(19) United States
(12) Patent Application Publication
(10) Pub. No.: US 2025/0264890 A1
(43) Pub. Date: Aug. 21, 2025

(54) FLUID DEVICE

(71) Applicant: HORIBA STEC, Co., Ltd., Kyoto-shi (JP)

(72) Inventor: Hiroshi HORIGUCHI, Kyoto-shi (JP)

(21) Appl. No.: 19/057,586

(22) Filed: Feb. 19, 2025

(30) Foreign Application Priority Data
Feb. 21, 2024 (JP) 2024-024952

(51) Int. Cl. G05D 7/06; G01F 1/34; G01F 15/00

(52) U.S. Cl. CPC G05D 7/0647; G01F 1/34; G01F 15/005

(57) ABSTRACT

According to the present invention, it is possible to fix a fluid resistance element to a flow path while reducing positional displacement or vibration of the fluid resistance element in the flow path. A fixing mechanism that fixes a fluid resistance element to an internal flow path includes: an element holder that holds the fluid resistance element; a holder mounting portion that is formed to communicate with the internal flow path in a flow path block and on which the element holder is mounted; and a seal member interposed between the element holder and the holder mounting portion. In a state where the seal member is crushed by the element holder and a surface facing the element holder in the holder mounting portion, the element holder is positioned and mounted on the holder mounting portion.

### CROSS-REFERENCE TO RELATED APPLICATION(S)

The present application is related to, and claims priority to Japanese Patent Application Serial No. 2024-024952, entitled “FLUID DEVICE,” filed on Feb. 21, 2024, the entire contents of which are incorporated herein by reference.

### BACKGROUND OF THE INVENTION

### 1. Technical Field

The present invention relates to a fluid device that controls or measures a physical quantity of a fluid.

### 2. Description of the Related Art

As a conventional fluid control device, as indicated in WO 2021/095492 A, there is a pressure type fluid control device in which a fluid resistance element is provided in an internal flow path through which a fluid flows. In the fluid control device, a flow rate of the fluid flowing through the internal flow path is measured from a differential pressure between an upstream-side pressure and a downstream-side pressure of the fluid resistance element, and the flow rate is controlled by a fluid control valve. In addition, as the fluid resistance element, a fluid resistance element made of ceramics (hereinafter, referred to as a ceramic restrictor) is used.

Here, there is a problem that it is difficult to fix the ceramic restrictor to the flow path from the viewpoint of a physical property that the ceramic is hardly deformed. Although, in WO 2021/095492 A, the cylindrical ceramic restrictor is fitted into a tubular covering member made of metal and further the covering member made of metal is fitted into the internal flow path in order to fix the ceramic restrictor, any of these fixing methods is technically difficult, and there are many problems in practical use.

Meanwhile, as a method for fixing the ceramic restrictor to the internal flow path, as illustrated in FIG. 8, a configuration is considered in which a flow path block in which the internal flow path is formed is divided into two in order to fix the ceramic restrictor. Specifically, the ceramic restrictor is inserted into the two divided blocks, and one O-ring is sandwiched between the two divided blocks. As a result, a gap between the ceramic restrictor and the internal flow path is sealed by the crushed O-ring, and the position of the ceramic restrictor is fixed.

However, in the fixing method described above, positional displacement of the ceramic restrictor occurs, which causes variation in response performance particularly in the fluid control device. Note that the variation in the response performance is caused by variation in an internal volume between the ceramic restrictor and the fluid control valve, for example, variation in time (response time of falling) until gas escapes from the internal volume at the time of falling of the flow rate or the like. In addition, since the ceramic restrictor is fixed by the O-ring, the ceramic restrictor vibrates due to the pressure received from the fluid, and the flow rate to be measured fluctuates.

### PRIOR ART DOCUMENT

### Patent Document

WO 2021/095492 A

### SUMMARY OF THE INVENTION

Therefore, the present invention has been made to solve the above-described problems, and an object of the present invention is to make it possible to fix a fluid resistance element to an internal flow path while reducing positional displacement or vibration of the fluid resistance element in the internal flow path.

That is, a fluid device according to the present invention is a fluid device that controls or measures a physical quantity of a fluid, including: a flow path block in which an internal flow path is formed; a fluid resistance element provided in the internal flow path and in which a resistance flow path communicating with the internal flow path is formed; and a fixing mechanism that fixes the fluid resistance element to the internal flow path, in which the fixing mechanism includes: an element holder that holds the fluid resistance element; a holder mounting portion that is formed to communicate with the internal flow path in the flow path block and on which the element holder is mounted; and a seal member interposed between the element holder and the holder mounting portion, and in a state where the seal member is crushed by the element holder and a surface facing the element holder in the holder mounting portion, the element holder is positioned and mounted on the holder mounting portion.

With such a fluid device, since the element holder is positioned and mounted on the holder mounting portion in a state where the seal member is crushed by the element holder holding the fluid resistance element and the surface facing the element holder in the holder mounting portion, it is possible to fix the fluid resistance element to the internal flow path while reducing positional displacement or vibration of the fluid resistance element in the internal flow path. As a result, it is possible to reduce variations in response performance due to the positional displacement of the fluid resistance element or to reduce fluctuation of a value to be measured due to the vibration of the fluid resistance element.

It is desirable that the element holder hold an end portion of the fluid resistance element in a state where the end portion extends to an outside, and the seal member seal between an extending portion of the fluid resistance element extending to the outside from the element holder and a surface facing the extending portion in the holder mounting portion.

With this configuration, it is possible to prevent the fluid from leaking from the gap between the fluid resistance element and the element holder and the gap between the element holder and the holder mounting portion.

It is desirable that the element holder or the holder mounting portion include a contact surface that is in contact with an end surface of the fluid resistance element in a state of holding the fluid resistance element.

With this configuration, the fluid resistance element can be positioned when the fluid device is assembled. In addition, in a case where the element holder or the holder mounting portion includes the contact surface that is in contact with the downstream-side end surface of the fluid resistance element, it is possible to suitably solve the problem that the fluid resistance element is displaced to the downstream side by the pressure received from the fluid when the fluid flows to the fluid resistance element.

It is desirable that an outlet of the resistance flow path be formed on a downstream-side end surface of the fluid resistance element, and the contact surface be in contact with a portion of the downstream-side end surface where the outlet is not formed.

With this configuration, it is possible to prevent the fluid resistance element from being displaced to the downstream side without hindering the flow rate characteristic of the fluid resistance element.

As a specific aspect of the fluid resistance element, the fluid resistance element can have a columnar shape, and a plurality of the resistance flow paths can be formed along an axial direction of the fluid resistance element. In this configuration, in order not to hinder the flow of the fluid with respect to the fluid resistance element, it is desirable that the element holder surround an outer peripheral surface of the fluid resistance element and hold the fluid resistance element.

In order to prevent the element holder from hindering the flow of the fluid because of holding the fluid resistance element by the element holder, it is desirable that the element holder include a lead-out portion that leads out the fluid flowing out from the resistance flow path to the internal flow path.

As a specific aspect of the fluid resistance element, as described above, the fluid resistance element can have a columnar shape, and a plurality of the resistance flow paths can be formed along the axial direction of the fluid resistance element. In this configuration, it is desirable that the element holder include: a tubular member that surrounds an outer peripheral surface of the fluid resistance element and holds the fluid resistance element, and sandwiches the seal member with the holder mounting portion; and a fixing member that is separate from the tubular member, and positions and fixes the tubular member to the holder mounting portion in a state where the tubular member crushes the seal member.

With this configuration, since the element holder has a separate configuration of the tubular member and the fixing member, each processing can be facilitated.

In order to prevent the element holder from hindering the flow of the fluid in a case where the element holder has a separate configuration of the tubular member and the fixing member, it is desirable that a lead-out portion that leads out the fluid flowing out from the resistance flow path to the internal flow path be formed in the tubular member and/or the fixing member.

It is desirable that the holder mounting portion be formed at a planar side surface of the flow path block, and the fluid resistance element be fixed substantially perpendicular to the side surface by mounting the element holder on the holder mounting portion.

With this configuration, processing of the holder mounting portion and the like in the flow path block can be facilitated.

In the present invention, if the fluid resistance element is a ceramic restrictor, the effects can be made more remarkable.

As a specific aspect of the fluid device, a flow rate sensor and a fluid control valve can be mounted on the block body, or a flow rate sensor or a pressure sensor can be mounted on the block body.

As described above, according to the present invention, it is possible to fix the fluid resistance element to the flow path while reducing positional displacement or vibration of the fluid resistance element in the flow path.

### BRIEF DESCRIPTION OF THE DRAWINGS

FIG. 1 is a diagram schematically illustrating a configuration of a fluid control device according to an embodiment of the present invention;

FIG. 2 is a perspective view illustrating a configuration of a fluid resistance element of the embodiment;

FIG. 3 is a cross-sectional view schematically illustrating a fixing mechanism of the embodiment;

FIG. 4 is a cross-sectional view schematically illustrating a state in which the fixing mechanism of the embodiment is disassembled;

FIG. 5 is a view schematically illustrating a tubular member and a second downstream-side flow path of the embodiment as viewed from below;

FIG. 6 is a cross-sectional view schematically illustrating a fixing mechanism of a modified embodiment;

FIG. 7 is a cross-sectional view schematically illustrating the fixing mechanism of the modified embodiment; and

FIG. 8 is a cross-sectional view schematically illustrating a conventional fixing method of a ceramic restrictor.

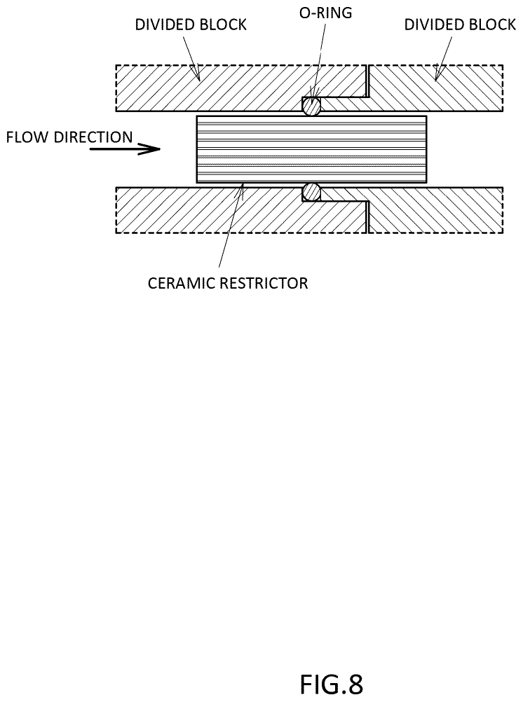

### DETAILED DESCRIPTION

Hereinafter, an embodiment of a fluid control device which is an example of a fluid device according to the present invention will be described with reference to the drawings. Note that each of the drawings below is schematically illustrated with appropriate omission or exaggeration for ease of understanding. The same components are denoted by the same reference numerals, and the description thereof will be omitted as appropriate.

### 1. BASIC CONFIGURATION OF FLUID CONTROL DEVICE 100

A fluid control device 100 according to the present embodiment is a so-called mass flow controller used in a semiconductor manufacturing process. Note that the fluid control device 100 can be used not only in the semiconductor manufacturing process but also in other processes.

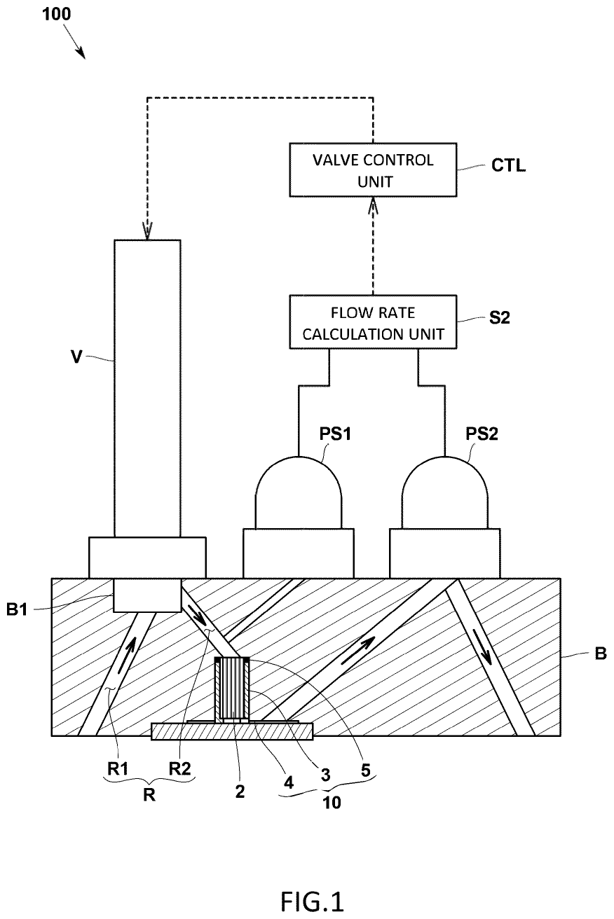

As illustrated in FIG. 1, the fluid control device 100 herein is a pressure type fluid control device. Specifically, the fluid control device 100 includes a flow path block B in which a flow path R (hereinafter, an internal flow path R) is provided, a fluid control valve V installed on the flow path block B, a pair of pressure sensors PS1 and PS2 that are fluid sensors installed at an upstream side or a downstream side of the fluid control valve V of the flow path block B, and a valve control unit CTL that performs feedback control of the fluid control valve V so that a flow rate value of the internal flow path R calculated based on pressure values measured by the pair of pressure sensors PS1 and PS2 gets close to a predetermined target value.

The flow path block B has a rectangular parallelepiped shape, for example, and the fluid control valve V and the pair of pressure sensors PS1 and PS2 are installed on a predetermined surface (upper surface in FIG. 1) of the flow path block B. In addition, the flow path block B is provided with a recessed accommodating portion B1 for installing the fluid control valve V on the predetermined surface thereof. The internal flow path R is divided into an upstream-side flow path R1 and a downstream-side flow path R2 by the accommodating portion B1. In the accommodating portion B1, one end of the upstream-side flow path R1 is opened to a bottom surface, and one end of the downstream-side flow path R2 is opened to a side surface.

The pair of pressure sensors PS1 and PS2 are each connected to the upstream side and the downstream side of a fluid resistance element 2 provided in the internal flow path R, and both of the pressure sensors PS1 and PS2 are connected to a flow rate calculation unit S2 that calculates a flow rate based on outputs of the pair of pressure sensors PS1 and PS2. The pair of pressure sensors PS1 and PS2 are attached to the predetermined surface (upper surface in FIG. 1) of the flow path block B in a line with the fluid control valve V.

The valve control unit CTL includes a so-called computer including a CPU, a memory, A/D and D/A converters, and the like, and each function is implemented by executing a program stored in the memory and cooperating various devices. Specifically, the feedback control of a valve opening degree of the fluid control valve V is performed so that the flow rate value calculated by the flow rate calculation unit S2 gets close to the target value stored in advance in the memory.

### 2. FLUID RESISTANCE ELEMENT 2 AND FIXING MECHANISM 10 OF FLUID RESISTANCE ELEMENT 2

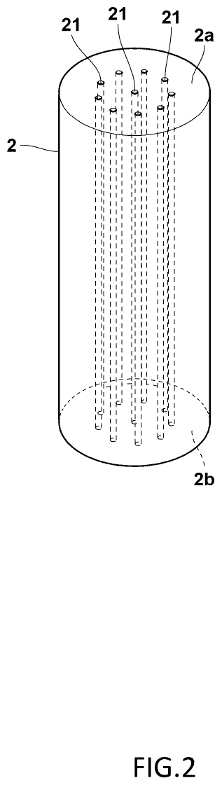

The fluid resistance element 2 of the present embodiment serves as resistance when the fluid flows, and as illustrated in FIG. 2, flow paths 21 (hereinafter, referred to as resistance flow paths 21) that communicate with the internal flow path R and serves as resistance is formed. The fluid resistance element 2 of the present embodiment is made of ceramics such as quartz, alumina, zirconia, or silicon nitride (ceramic restrictor).

The fluid resistance element 2 has a cylindrical shape, for example, and one or a plurality of (for example, about several hundreds) the resistance flow paths 21 is formed along an axial direction. The fluid resistance element 2 herein has a diameter dimension (outer diameter) of about several millimeters (for example, 1.5 mm) and a length dimension (dimension along the axial direction) of about several millimeters to several tens of millimeters (for example, 7 mm), but these dimensions may be appropriately changed.

The resistance flow path 21 is formed penetrating the fluid resistance element 2 in the axial direction. That is, an inlet of the resistance flow path 21 is formed on one axial end surface 2a (upstream-side end surface 2a) of the fluid resistance element 2, and an outlet of the resistance flow path 21 is formed on the other axial end surface 2b (downstream-side end surface 2b) of the fluid resistance element 2. The resistance flow path 21 of the present embodiment has a linear shape with a circular cross section. The resistance flow path 21 herein has a diameter dimension (inner diameter) of less than 1 millimeter and about several tens of micrometers (for example, 30 km), and a length dimension (dimension along the axial direction) is about several millimeters to several tens of millimeters (for example, 7 mm) which is the same as that of the fluid resistance element 2, but these dimensions may be appropriately changed.

As illustrated in FIGS. 1, 3, and 4, the fluid control device 100 of the present embodiment further includes a fixing mechanism 10 that fixes the fluid resistance element 2 to the internal flow path R of the flow path block B.

As illustrated in FIGS. 1 and 3 to 5, the fixing mechanism 10 includes an element holder 3 that holds the fluid resistance element 2, a holder mounting portion 4 formed in the flow path block B and on which the element holder 3 is mounted, and a seal member 5 interposed between surfaces facing the element holder 3 and the holder mounting portion 4. In a state where the seal member 5 is crushed by the surfaces facing the element holder 3 and the holder mounting portion 4, the fixing mechanism 10 positions and fixes the element holder 3 holding the fluid resistance element 2 to the holder mounting portion 4.

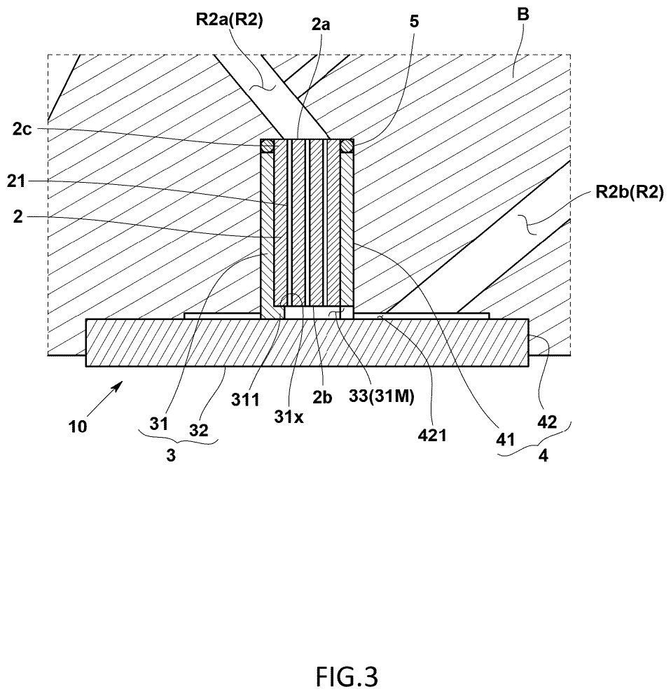

Specifically, as illustrated in FIGS. 3 to 5, the element holder 3 includes a tubular member 31 that surrounds an outer peripheral surface of the fluid resistance element 2 and holds the fluid resistance element 2, and a fixing member 32 that is separate from the tubular member 31 and fixes the tubular member 31 to the holder mounting portion 4.

The tubular member 31 is made of a tubular metal that accommodates and holds the fluid resistance element 2 therein. In addition, the tubular member 31 sandwiches the seal member 5 with the holder mounting portion 4. The tubular member 31 includes a contact surface 31x that is in contact with the downstream-side end surface 2b of the fluid resistance element 2 in a state of holding the fluid resistance element 2. The contact surface 31x includes a protrusion portion 311 protruding radially inward from an inner peripheral surface of the tubular member 31. The protrusion portion 311 is formed on a lower end portion side on the inner peripheral surface of the tubular member 31. In addition, the contact surface 31x is in contact with a portion of the downstream-side end surface 2b of the fluid resistance element 2 where the outlet is not formed, and in the present embodiment, the contact surface is in contact with a peripheral portion of the downstream-side end surface 2b of the fluid resistance element 2.

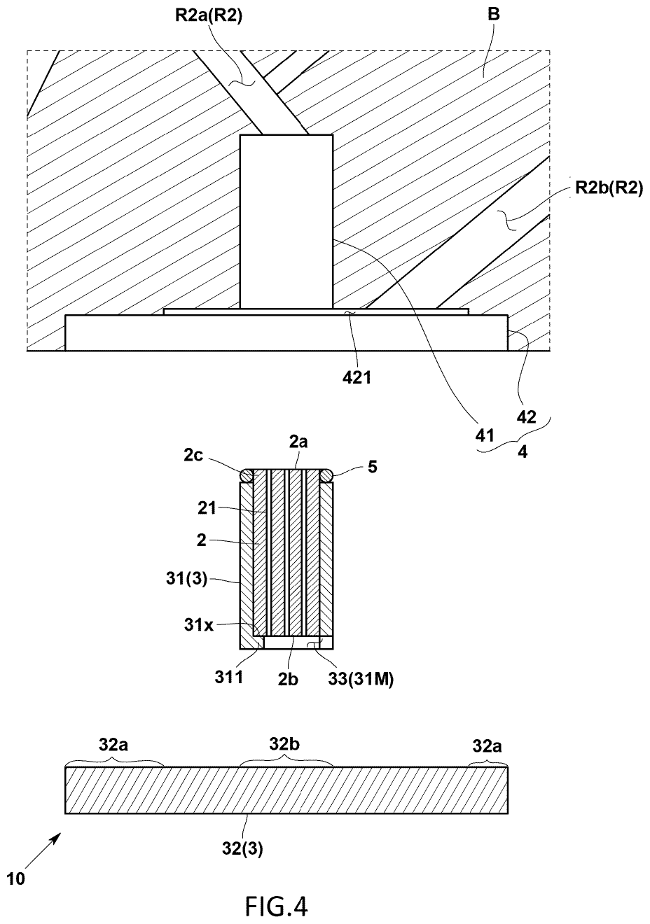

The tubular member 31 of the present embodiment is configured such that an upper end portion 2c of the fluid resistance element 2 extends to the outside from an upper end opening portion of the tubular member 31 in a state of accommodating and holding the fluid resistance element 2. An O-ring, which is the seal member 5, is attached to the outer peripheral surface of the upper end portion 2c which is an extending portion extending from the tubular member 31 in the fluid resistance element 2 (see FIG. 4). As a result, when the tubular member 31 is mounted on the holder mounting portion 4, the O-ring 5 is sandwiched and crushed between the upper end surface of the tubular member 31 and the inner surface of the holder mounting portion 4 (a surface facing the upper end surface of the tubular member 31).

The fixing member 32 positions and fixes the tubular member 31 to the holder mounting portion 4 in a state where the tubular member 31 crushes the seal member 5. The fixing member 32 of the present embodiment is made of metal having a rectangular flat plate shape in plan view, for example. The fixing member 32 is fixed to a lower surface of the flow path block B with, for example, a screw.

The holder mounting portion 4 is a recess portion formed at a planar side surface (lower surface in FIG. 1) of the flow path block B. As illustrated in FIGS. 3 and 4, the holder mounting portion 4 of the present embodiment includes a first recess portion 41 that accommodates the tubular member 31 and a second recess portion 42 that accommodates the fixing member 32. Note that the holder mounting portion 4 may not include the second recess portion 42. In addition, the downstream-side flow path R2 is divided into a first downstream-side flow path R2a and a second downstream-side flow path R2b by the holder mounting portion 4.

The first recess portion 41 is formed substantially perpendicular to the lower surface of the flow path block B and accommodates the tubular member 31. The first recess portion 41 has substantially the same shape as an outer shape of the tubular member 31, and has a circular cross-sectional shape in the present embodiment. One end of the first downstream-side flow path R2a is opened to a bottom surface of the first recess portion 41. Note that a peripheral portion of an opening of the first downstream-side flow path R2a on the bottom surface of the first recess portion 41 serves as the inner surface of the holder mounting portion 4 that sandwiches the O-ring 5 with the upper end surface of the tubular member 31.

Similarly to the first recess portion 41, the second recess portion 42 is formed substantially perpendicular to the lower surface of the flow path block B and accommodates the fixing member 32. The second recess portion 42 has a shape corresponding to an outer shape of the fixing member 32, and has a rectangular cross-sectional shape in the present embodiment. One end of the second downstream-side flow path R2b is opened to a bottom surface of the second recess portion 42. Note that the second downstream-side flow path R2b may have a configuration in which one end opens to an inner surface of the first recess portion 41. In addition, a flow path portion 421 for guiding the fluid flowing out from the fluid resistance element 2 to the second downstream-side flow path R2b may be formed on the bottom surface of the second recess portion 42.

By mounting the element holder 3 on the holder mounting portion 4 configured as described above, the fluid resistance element 2 is fixed substantially perpendicular to the lower surface. Specifically, the tubular member 31 holding the fluid resistance element 2 and the O-ring 5 are accommodated in the first recess portion 41 of the holder mounting portion 4, and by accommodating and fixing the fixing member 32 in the second recess portion 42 in this state, the O-ring 5 is crushed between the upper end surface of the tubular member 31 and the bottom surface of the first recess portion 41 (the surface facing the upper end surface of the tubular member 31). By crushing the O-ring 5 in this manner, sealing ability between the inner surface of the first recess portion 41 and the upper end surface of the tubular member 31 is secured. In addition, the O-ring 5 is in close contact with the outer peripheral surface of the upper end portion 2c, which is the extending portion extending outward from the element holder 3 of the fluid resistance element 2, and with the inner surface of the first recess portion (the surface facing the outer peripheral surface of the upper end portion 2c). In the fixing mechanism 10, by fixing the fixing member 32 to the second recess portion 42, the fixing member 32 is positioned with respect to the flow path block B (internal flow path R), and the element holder 3 fixed in contact with the fixing member 32 is positioned with respect to the flow path block B (internal flow path R). As a result, the fluid resistance element 2 held by the element holder 3 is positioned with respect to the flow path block B (internal flow path R).

Here, as illustrated in FIG. 4, the fixing member 32 includes a mounting surface 32a to be mounted on the second recess portion 42, and a pressing surface 32b configured to crush the O-ring 5 via the tubular member 31 in a state where the mounting surface 32a is mounted on the second recess portion 42. In the present embodiment, the mounting surface 32a and the pressing surface 32b are formed on the same flat surface. Therefore, in a state where the fixing member 32 is mounted on the second recess portion 42, the total of the axial length of the tubular member 31 and the thickness of the O-ring 5 in the natural state along the axial direction is larger than the distance between the upper surface (pressing surface 32a) of the fixing member 32 and the bottom surface of the first recess portion 41. The axial length of the tubular member 31 is shorter than the distance between the upper surface (pressing surface 32a) of the fixing member 32 and the bottom surface of the first recess portion 41. With this configuration, when the fixing member 32 is mounted on the second recess portion 42, the tubular member 31 and the fluid resistance element 2 are positioned in the vertical direction (axial direction) by the O-ring 5. In addition, the O-ring 5 is in contact with the outer peripheral surface of the fluid resistance element 2 and the inner surface of the holder mounting portion 4, so that the tubular member 31 and the fluid resistance element 2 are positioned in the left-right direction (direction orthogonal to the axial direction). Thus, the O-ring 5 fills the gap formed by the outer peripheral surface of the upper end portion 2c of the fluid resistance element 2, the upper end surface of the element holder 3 (the tubular member 31), and the surfaces of the holder mounting portion 4 facing the outer peripheral surface and the upper end surface. As a result, the fluid resistance element 2 and the tubular member 31 are positioned with respect to the holder mounting portion 4 by the O-ring 5.

In a state where the element holder 3 is mounted on the holder mounting portion 4, the upstream-side end surface 2a of the fluid resistance element 2 held by the tubular member 31 may have a gap with the bottom surface of the first recess portion 41, so that no stress may be applied to the fluid resistance element 2. Note that, in the state where the element holder 3 is mounted on the holder mounting portion 4, the upstream-side end surface 2a of the fluid resistance element 2 held by the tubular member 31 may be in contact with the bottom surface of the first recess portion 41.

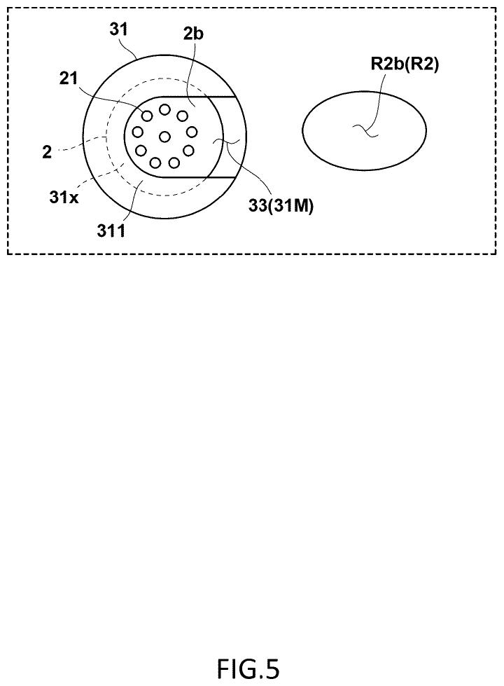

Furthermore, in the present embodiment, as illustrated in FIGS. 3 to 5, the element holder 3 includes a lead-out portion 33 that leads out the fluid flowing out from the resistance flow path 21 to the downstream-side flow path R2 (second downstream-side flow path R2b). Specifically, the lead-out portion 33 that leads out the fluid flowing out of the resistance flow path 21 to the downstream-side flow path R2 (second downstream-side flow path R2b) is formed in the tubular member 31 and/or the fixing member 32. In the present embodiment, a groove 31M serving as the lead-out portion for leading out the fluid flowing out from the resistance flow path 21 to the second downstream-side flow path R2b is formed at a lower end portion of the tubular member 31. The groove 31M communicates the downstream-side end surface 2b of the fluid resistance element 2 with the opening of the second downstream-side flow path R2b. In addition, the groove 31M is a notch formed at the lower end portion of the tubular member 31, and extends from a center portion of the fluid resistance element 2 toward the second downstream-side flow path R2b as illustrated in FIG. 5. Note that the form of the groove 31M (notch) can be variously changed, and may be formed over the entire radial direction of the tubular member 31, for example. Through the lead-out portion 33 configured as described above, the fluid flows to the downstream-side flow path R2 (second downstream-side flow path R2b) directly or via the flow path portion 421 formed in the second recess portion 42.

### 3. EFFECTS OF PRESENT EMBODIMENT

As described above, according to the fluid control device 100 of the present embodiment, since the element holder 3 is positioned and mounted on the holder mounting portion 4 in a state where the seal member 5 is crushed by the element holder 3 holding the fluid resistance element 2 and the holder mounting portion 4, it is possible to fix the fluid resistance element 2 to the internal flow path R while reducing the positional displacement or vibration of the fluid resistance element 2 in the internal flow path R. As a result, it is possible to reduce variations in response performance due to positional displacement of the fluid resistance element 2 or to reduce fluctuation of a measured value due to vibration of the fluid resistance element 2.

### 4. OTHER EMBODIMENTS

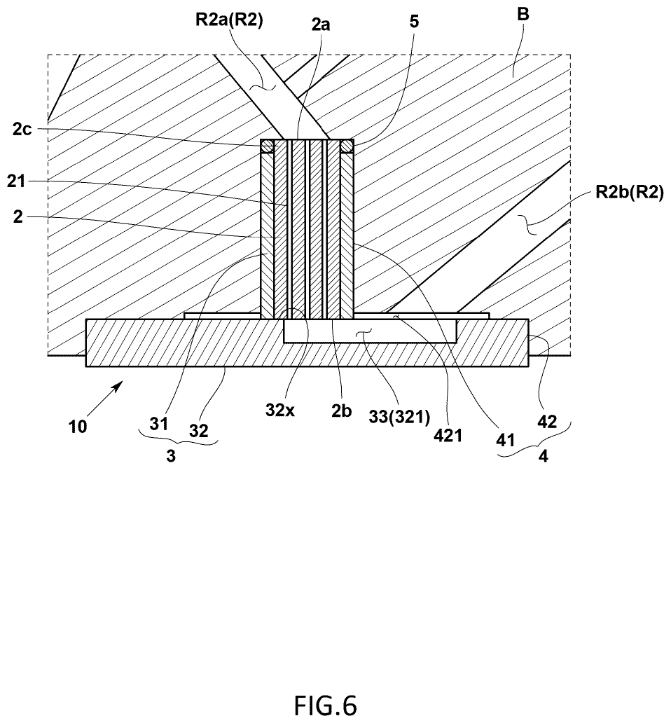

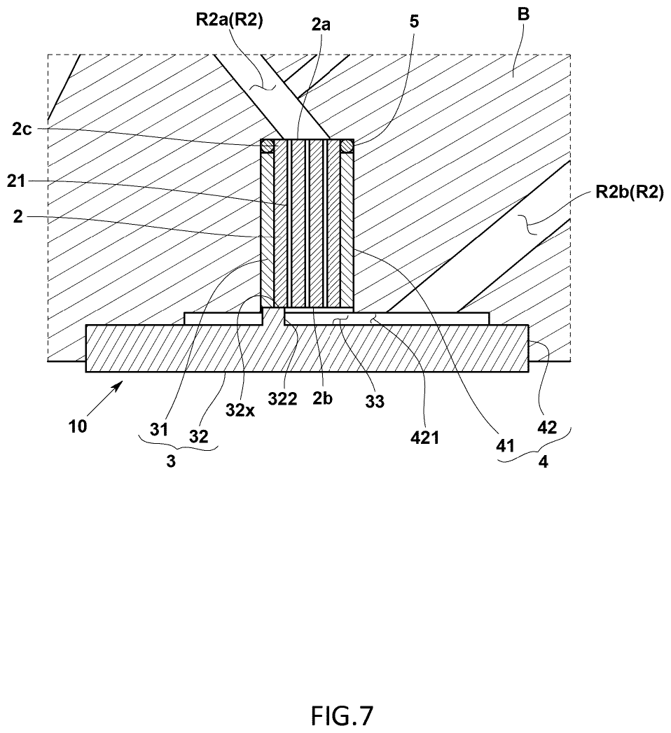

For example, in the above embodiment, the tubular member 31 is provided with the contact surface 31x that is in contact with the downstream-side end surface 2b of the fluid resistance element 2, but as illustrated in FIGS. 6 and 7, an upper surface of a fixing member 32 may have a contact surface 32x that is in contact with a downstream-side end surface 2b of a fluid resistance element 2. Since a tubular member 31 does not need to be provided with a protrusion portion 311, the tubular member 31 can be formed in a tubular shape having an equal cross-sectional shape along the axial direction. In addition, a holder mounting portion 4 may have a contact surface that is in contact with an end surface of the fluid resistance element 2.

In this case, the fixing member 32 can be provided with a lead-out portion 33 that leads out the fluid flowing out from a resistance flow path 21 to the second downstream-side flow path R2b. Specifically, as illustrated in FIG. 6, the lead-out portion 33 may be formed by forming a recess portion 321 on the upper surface of the fixing member 32. The recess portion 321 communicates the downstream-side end surface 2b of the fluid resistance element 2 with an opening of the second downstream-side flow path R2b. As illustrated in FIG. 7, the lead-out portion 33 may be formed by forming a convex portion 322 on the upper surface of the fixing member 32. The upper surface of the convex portion 322 is in contact with both a lower end surface of the tubular member 31 and the downstream-side end surface 2b of the fluid resistance element 2, so that a gap formed between the upper surface of the fixing member 32 and the fluid resistance element 2 becomes the lead-out portion 33.

Furthermore, in the above embodiment, the element holder 3 is configured to be separated by the tubular member 31 and the fixing member 32, but a tubular member 31 and a fixing member 32 may be integrally formed.

In the above embodiment, the fluid resistance element 2 is fixed substantially perpendicular to the planar side surface (lower surface) of the flow path block B, but a fluid resistance element 2 may be fixed obliquely to a planar side surface (lower surface) of a flow path block B or may be fixed horizontally.

In the above embodiment, one seal member 5 (O-ring) is provided at the upper end portion 2c which is the extension of the fluid resistance element 2, but a plurality of seal members 5 (O-rings) may be provided at an upper end portion 2c of a fluid resistance element 2 along the vertical direction (axial direction).

In addition, in the above embodiment, the fluid control device 100 has been described as a pressure type, but may be a thermal type. The thermal type fluid control device 100 includes a thermal sensor in which a resistance temperature detector is provided in a bypass path branching from an internal flow path R of a flow path block B and joining again. In this configuration, the fluid resistance element 2 is fixed as a laminar flow element between the branch point and the junction point of the bypass path in the internal flow path R using the fixing mechanism of the above embodiment.

In the above embodiment, as an actuator of the fluid control valve V, one using a piezo element (piezo stack) or one using a solenoid can be used.

The fluid device of the present invention is not limited to the fluid control device as in the above embodiment, and may be a flow rate meter in which a flow rate sensor is mounted on a block body or a pressure gauge in which a pressure sensor is mounted on the block body.

In addition, various modifications and combinations of the embodiments may be made without departing from the gist of the present invention.

### REFERENCE CHARACTER LIST

100 Fluid control device (fluid device)
V Fluid control valve
R Internal flow path
B Flow path block
PS1, PS2 Pressure sensor (flow rate sensor)
2 Fluid resistance element
21 Resistance flow path
2b Downstream-side end surface
10 Fixing mechanism
3 Element holder
31 Tubular member
31x Contact surface
32 Fixing member
33 Lead-out portion
4 Holder mounting portion
5 Seal member

What is claimed is:

1. A fluid device that controls or measures a physical quantity of a fluid, comprising:
a flow path block in which an internal flow path is formed;
a fluid resistance element provided in the internal flow path and in which a resistance flow path communicating with the internal flow path is formed; and
a fixing mechanism that fixes the fluid resistance element to the internal flow path,
wherein
the fixing mechanism includes:
an element holder that holds the fluid resistance element;
a holder mounting portion that is formed to communicate with the internal flow path in the flow path block and on which the element holder is mounted; and
a seal member interposed between the element holder and a surface facing the element holder in the holder mounting portion, and
in a state where the seal member is crushed by the element holder and the holder mounting portion, the element holder is positioned and mounted on the holder mounting portion.

2. The fluid device according to claim 1, wherein
the element holder holds an end portion of the fluid resistance element in a state where the end portion extends to an outside, and
the seal member seals between an extending portion of the fluid resistance element extending to the outside from the element holder and a surface facing the extending portion in the holder mounting portion.

3. The fluid device according to claim 1, wherein the element holder or the holder mounting portion includes a contact surface that is in contact with an end surface of the fluid resistance element in a state of holding the fluid resistance element.

4. The fluid device according to claim 3, wherein
an outlet of the resistance flow path is formed on a downstream-side end surface of the fluid resistance element, and
the contact surface is in contact with a portion of the downstream-side end surface where the outlet is not formed.

5. The fluid device according to claim 1, wherein
the fluid resistance element has a columnar shape and a plurality of the resistance flow paths is formed along an axial direction of the fluid resistance element, and
the element holder surrounds an outer peripheral surface of the fluid resistance element and holds the fluid resistance element.

6. The fluid device according to claim 1, wherein the element holder includes a lead-out portion that leads out the fluid flowing out from the resistance flow path to the internal flow path.

7. The fluid device according to claim 1, wherein
the fluid resistance element has a columnar shape and a plurality of the resistance flow paths is formed along an axial direction of the fluid resistance element, and
the element holder includes:
a tubular member that surrounds an outer peripheral surface of the fluid resistance element and holds the fluid resistance element, and sandwiches the seal member with the holder mounting portion; and
a fixing member that is separate from the tubular member, and positions and fixes the tubular member to the holder mounting portion in a state where the tubular member crushes the seal member.

8. The fluid device according to claim 7, wherein a lead-out portion that leads out the fluid flowing out from the resistance flow path to the internal flow path is formed in the tubular member and/or the fixing member.

9. The fluid device according to claim 5, wherein
the holder mounting portion is formed at a planar side surface of the flow path block, and
the fluid resistance element is fixed substantially perpendicular to the side surface by mounting the element holder on the holder mounting portion.

10. The fluid device according to claim 1, wherein the fluid resistance element is a ceramic restrictor.

11. The fluid device according to claim 1, wherein the fluid device is a device in which a flow rate sensor and a fluid control valve are mounted on the block body.

12. The fluid device according to claim 1, wherein the fluid device is a device in which a flow rate sensor or a pressure sensor is mounted on the block body.
